(19) United States
(12) Patent Application Publication
(10) Pub. No.: US 2007/0038770 A1
(43) Pub. Date: Feb. 15, 2007

(54) Method for implementing service customization on session initiation protocol application server

(75) Inventor: Liming Zhang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/500,082

(22) Filed: Aug. 7, 2006

Related U.S. Application Data
(63) Continuation of application No. PCT/CN04/01459, filed on Dec. 16, 2004.

(30) Foreign Application Priority Data
Feb. 27, 2004 (CN) 200410005792.8

(51) Int. Cl. G06F 15/16

(52) U.S. Cl. 709/230

(57) ABSTRACT

The present invention discloses a method for providing customized service for users, including: a SIP AS receives service customization request sent by a user via a SIP client; the SIP AS extracts service customization information from the request and provides the service corresponding to the service customization information for the SIP client. By the present invention, the user can perform customized configuration at the SIP client without the aid of WEB AS, so as to facilitate utilizations of users, and realize generation and uploading of completely customized service customization script. Additionally, the present invention can put service customization into effect immediately instead of going into effect until the service is used again. The method of the present invention just needs to add a special SIP service in SIP AS, thereby making full use of the resources and characteristics of SIP AS, facilitating the utilization and improving the effectiveness.

### CROSS-REFERENCES TO RELATED APPLICATIONS

This is a continuation of International Application No. PCT/CN2004/001459, which was filed on Dec. 6, 2004and which, in turn, claimed the benefit of Chinese Patent Application No. 20041005792.8, which was filed on Feb. 27, 2004, the entire disclosures of which are hereby incorporated herein by reference.

### BACKGROUND OF THE INVENTION

1. Field of the Invention

The present invention relates to Session Initiation Protocol (SIP) application technology, and more specifically to a method for providing customized service and a system thereof.

2. Background of the Invention

SIP is an IP phone signaling protocol proposed by the Internet Engineering Task Force (IETF), and is applied in the IP network signaling control and communication with soft switch, so as to constitute the next generation value-added business platform and provide better value-added services for telecommunication, banking and financial businesses.

Because of its advantages of easy to understand, extend and implement, SIP has gradually turned into an important protocol of the multimedia subsystem in Next Generation Network (NGN) and the 3rd Generation (3G) Network. At present, more and more SIP-supported client software and intelligent multimedia terminals as well as SIP-based servers and soft switch devices are emerging.

SIP services refer to SIP-based applications, e.g. Voice over Internet Protocol (VoIP), presence service, Instant Message (IM) service.

SIP AS is a functional entity adapted for controlling and executing self-stored SIP services. It is the most important part in communication networks that adopt SIP as multimedia session control protocol. SIP AS faces the whole IP network, and seamlessly integrates the technologies of voice, data, video, massage and WEB to meet all demands of Internet and mobile communication.

In the times of NGN and 3G, development of SIP service is divided into three phases: the first phase is characterized by Voice over Packet (VoP) and simple multimedia services; the second phase is characterized by plenty of multimedia services guaranteed by Quality of Services (QoS); the third phase is characterized by customized and virtualized services. In the third phase, the third party service providers will provide plenty of services to networks, and the customized and virtualized services present a trend of booming growth, therefore, the customized service will occupy an important position in NGN and 3G.

So, it is a great issue in SIP applications that how to implement service customization on SIP AS. The following is the technical solution to implementation of customized services in prior art.

FIG. 1 illustrates a location of a SIP AS in a SIP network. As shown in this figure, a SIP client is connected with a SIP AS via the SIP network.

The SIP client is client software or equipment that supports SIP applications, e.g. SIP-based multimedia PC soft terminal, SIP-based mobile phone, SIP-based multimedia WEB client software, and SIP-based Personal Digital Assistant (PDA) client software.

In some specific application environments, SIP network includes multiple network nodes. For example, in 3GPP R5 service environment, the network nodes that a typical SIP network might comprise are proxy servers, redirect servers, registrar/location servers, Serving Call Session Control Function (SCSCF) and SIP AS. The SIP request from the SIP client is sent to the SIP AS via the above network nodes.

The technical solution to implement service customization in prior art is to set up a subsystem that is logically independent from the SIP AS. The subsystem mainly comprises a WEB AS and a database. The WEB AS functions to collect users' customized information and store the customized information in the database. Therefore, when a user uses a certain service once again, the SIP AS will perform corresponding configuration according to the customized information in the database, so that the user gets his customized service experience.

FIG. 2 is a system construction illustrating the service customization in prior art. As shown in this figure, a WEB server and a database are logically independent from a SIP AS. The client with which the user carries out service customization is generally a PC. The service customization script is generated at the WEB AS.

FIG. 3 is a flow illustrating the method for implementing service customization in prior art. As shown in this figure, the method for implementing service customization includes:
Step 301: The WEB server provides options of service customization for the client.
Step 302: The client sets up the service customization according to the options from the WEB server.
Step 303: The client sends the service customization information to the WEB server.
Step 304: The WEB server generates the service customization script.
Step 305: The WEB server stores the service customization script into the database.

When the user requests a service once again, the SIP AS accesses the database and obtains the user's service customization information and carries out corresponding configuration, so as to achieve the object of customization demanded by the user.

However, the technical solution in prior art is complicated to implement, and should rely on a WEB AS to realize service customization. Further, the service customization configuration won't go into effect until a user uses the service once again. It is difficult for users to realize uploading and configuration of a whole customized SIP service.

### SUMMARY OF THE INVENTION

The present invention provides a method for providing customized service for users and a system thereof.

The method for providing customized service for users includes: sending, by a client, a service customization request containing service customization information; upon receiving the service customization request, a server obtaining the service customization information from the service customization request; the server providing the service corresponding to the service customization request for the client based on the service customization information.

The system for providing customized service for users includes: a client, a user is able to set service customization information via the client; the customized service is contained in a service customization request; a communication network connected to the client; a server connected to the client via the communication network, upon receiving the service customization request, the server obtaining the service customization information from the service customization request, and providing the service corresponding to the service customization request for the client based on the service customization information.

The method for providing customized service for users applied to a communication network based on a Session Initiation Protocol (SIP) includes: sending, by a SIP client, a service customization request containing service customization information; upon receiving the service customization request, a SIP Application Server (AS) obtaining the service customization information from the service customization request; the SIP AS providing the service corresponding to the service customization request for the SIP client based on the service customization information.

From the above mentioned technical solution, a user can generate his service customization script at a SIP client, and send his service customization request message carrying the script to a SIP AS via the SIP client. The SIP AS extracts the service customization script from the request message and stores the script.

In the present invention, the SIP AS decides whether the user uses the service after it extracts the service customization script from the service customization request message, if so, it immediately applies the service customization script to the service.

### BRIEF DESCRIPTION OF THE DRAWINGS

FIG. 1 is a schematic diagram illustrating location of SIP AS in SIP application.

FIG. 2 is a schematic diagram illustrating the system construction of technical solution to implement service customization in prior art.

FIG. 3 is a flow illustrating the technical solution to implement service customization in the prior art.

FIG. 4 is a schematic diagram illustrating the system construction of the solution to implementing service customization in accordance with an embodiment of the present invention.

FIG. 5 is a schematic diagram illustrating the solution to implement service customization in accordance with an embodiment of the present invention.

FIG. 6 is a flow illustrating the technical solution to implement service customization in SIP AS in accordance with an embodiment of the present invention.

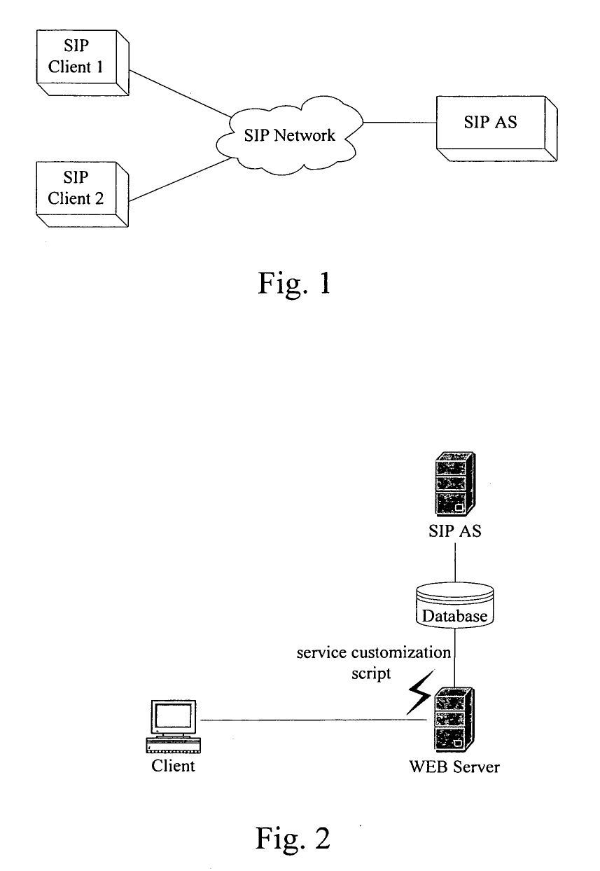

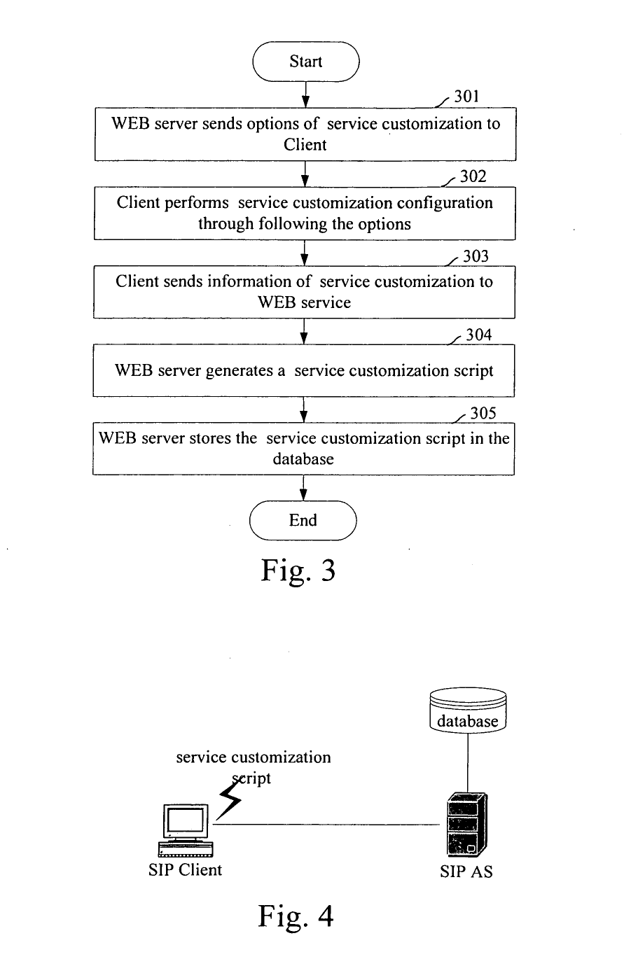

### DETAILED DESCRIPTION OF PREFERRED EMBODIMENTS

In order to make the solution and merits of the present invention clearer, a detailed description of the present invention is hereinafter given with reference to specific embodiments and the accompanying drawings.

FIG. 4 is a schematic diagram illustrating the system construction of the solution to implement service customization in accordance with an embodiment of the present invention. As shown in this figure, the logical functional entities in the system include a SIP client, a SIP AS and a database.

The SIP client is adapted for generating and submitting service customization script, which is a logical expression of a user's customized configuration of a SIP service. If the SIP service is configurable, the user can do the configuration of the SIP service according to his interests, and the configuration information is stored in a script, and this script is the service customization script corresponding to the customized service configuration. The user can do the configuration at the SIP client according to the instructions issued by the SIP AS to generate his service customization script. The user can also generate a complete service customization script by himself, for instance, a Call Processing Language (CPL) script which implements call forwarding.

The SIP AS processes various SIP service requests. The SIP AS should be configured with a special SIP service apart from its common services to implement customization, and the special service is called customization service. Unlike the common SIP services, the customization service dedicates to processing SIP service customization request messages from SIP clients, i.e., this service specially serves to achieve SIP service customization function, and serves for operation to create, store, inquire, delete and replace users' service customization scripts. When a SIP client requests service customized, the SIP AS executes the customization service.

The database serves to store the service customization scripts and users' service subscription information.

In the embodiment of the invention, the customization service in the SIP AS is used to process the service customization request messages. When a SIP client sends a service customization request message to the SIP AS, the SIP AS executes the customization service.

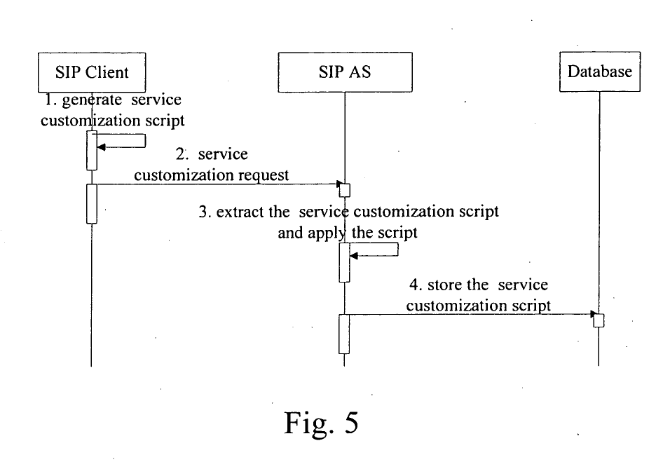

FIG. 5 is a schematic diagram illustrating the solution to implement service customization in accordance with an embodiment of the present invention. This figure shows the logical sequence of operations on a SIP client, a SIP AS and a database, and information transferred among above-mentioned three entities. The SIP client generates a service customization script and sends to the SIP AS a service customization request message carrying the generated service customization script. The SIP AS extracts the service customization script from the service customization request message, and stores the service customization script in the database.

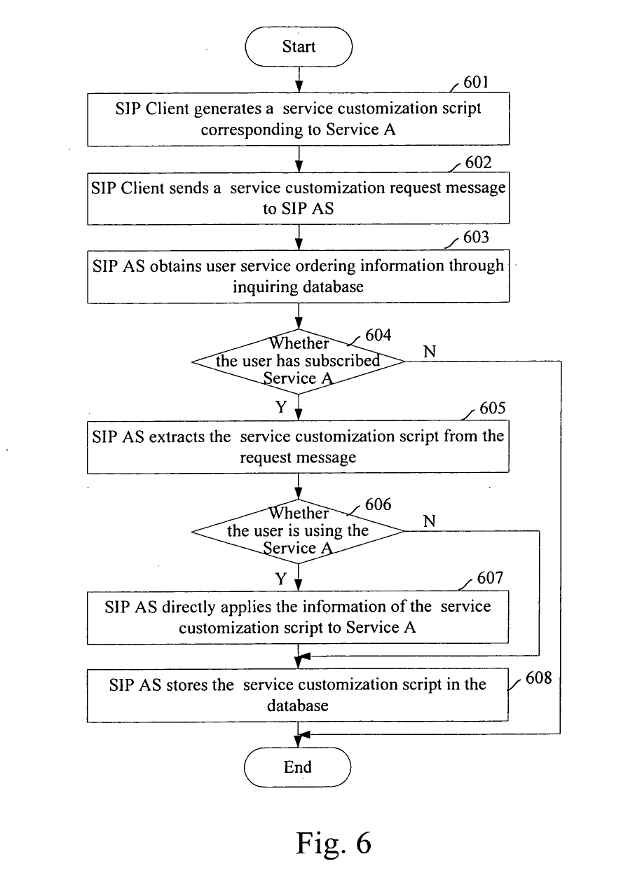

FIG. 6 is a flow illustrating the method for implementing service customization in accordance with an embodiment of the present invention. In this embodiment, the user needs to perform customized configuration of a SIP service, and the SIP service in this embodiment is called Service A. As shown in this figure, the implementation of the customized service mainly includes the following steps:

Step 601: Generating a service customization script for Service A at the SIP client. The script can be generated in many ways, for instance, the user can generate the script at the SIP client following the guide and prompts of the SIP AS, or generate a script by programming. The script can be any of the general types of service scripts, e.g. Call Processing Language (CPL) script, Common Gateway Interface (CGI) script, SIP Servlet script, or a script of configuration file.

Step 602: The SIP client initiates the service customization service, sends to the SIP AS a service customization request message carrying the service customization script generated in Step 601.

Step 603: The SIP AS inquires the database to obtain the user's service subscription information upon receiving the service customization request message.

Step 604: The SIP AS decides whether the user has subscribed to Service A, if so, proceeds to Step 605; otherwise, ends the current procedure.

Step 605: The SIP AS extracts the service customization script from the service customization request message.

Step 606: The SIP AS decides whether the user is currently using Service A, if so, proceeds to Step 607; otherwise, proceeds to Step 608.

Step 607: The SIP AS applies contents of the service customization script to Service A, i.e., combines the service customization script and service script of Service A, so that the user can immediately use Service A with customized configuration.

Step 608: The SIP AS stores the service customization script in the database.

Steps 603˜608 are the service flow of customization service in SIP AS. When the user requests to use Service A again, the SIP AS decides whether the user has made customized configuration for Service A by inquiring the database, if the user has already made customized configuration for Service A, the SIP AS fetches the service customization script from the database and applies the script to Service A; otherwise, the SIP AS directly executes Service A.

As shown in the flow of FIG. 6, the customization service needs to decide whether the user is using Service A after the customization service extracts the service customization script, and if the user is using Service A, it immediately applies the service customization script to Service A; otherwise, it directly stores the service customization script in the database. Therefore, the user's service customization can be applied immediately to the service with customized configuration instead of going into effect until the user uses the service next time.

The method of the present invention can be modified appropriately in specific embodiment process to meet the specific requirements of specific cases. It is thereby understood that the specific embodiments according to the present invention are just demonstrative and are not incline to limit the protection scope thereof.

1. A method for providing customized service for users, comprising:
sending, by a client, a service customization request containing service customization information;
upon receiving the service customization request, a server obtaining the service customization information from the service customization request;
the server providing the service corresponding to the service customization request for the client based on the service customization information.

2. The method according to claim 1, wherein the service customization information is a service customization script;
the step of obtaining the service customization information comprises: the server extracting the service customization script from the service customization request.

3. The method according to claim 2, further comprising:
storing the service subscription information in the server;
upon receiving the service customization request, the server determining whether the user has subscribed to the service corresponding to the service customization request by inquiring the stored service subscription information, and if the user subscribed to the service, extracting the service customization script from the service customization request.

4. The method according to claim 2, further comprising:
after extracting the service customization script from the service customization request, the server determining whether the user is using the service corresponding to the service customization request, if yes, combining the service customization script with a service script, and storing the service customization script; otherwise, storing the service customization script directly.

5. A system for providing customized service for users, comprising:
a client, a user is able to set service customization information via the client; the customized service is contained in a service customization request;
a communication network connected to the client;
a server connected to the client via the communication network, upon receiving the service customization request, the server obtaining the service customization information from the service customization request, and providing the service corresponding to the service customization request for the client based on the service customization information.

6. The system according to claim 5, wherein the server further comprise a database for storing the service customization information.

7. The system according to claim 5, wherein the communication network is based on Session Initiation Protocol (SIP);
the client is a SIP client;
the server is a SIP Application Server (AS).

8. A method for providing customized service for users, applied to a communication network based on a Session Initiation Protocol (SIP), comprising:
sending, by a SIP client, a service customization request containing service customization information;
upon receiving the service customization request, a SIP Application Server (AS) obtaining the service customization information from the service customization request;
the SIP AS providing the service corresponding to the service customization request for the SIP client based on the service customization information.

9. The method according to claim 8, wherein the service customization information is a service customization script;
the step of obtaining the service customization information comprises: the SIP AS extracting the service customization script from the service customization request.

10. The method according to claim 9, further comprising:
storing the service subscription information of the user in the SIP AS;
upon receiving the service customization request, the SIP AS determining whether the user has subscribed to the service corresponding to the service customization request by inquiring the stored service subscription information, and if yes, extracting the service customization script from the service customization request.

11. The method according to claim 9, further comprising:
after extracting the service customization script from the service customization request, the SIP AS determining whether the user is using the service, if yes, combining the service customization script with a service script, and storing the service customization script; otherwise, storing the service customization script directly.

12. The method according to claim 9, wherein the service customization script is generated by following instructions issued by the SIP AS at the SIP client.

13. The method according to claim 9, wherein the service customization script is generated by the user at the SIP client.

14. The method according to claim 9, wherein the service customization script is a SIP script of call processing language type, a universal gateway interface type or a SIP servlet type.

15. The method according to claim 9, wherein the service customization script is a configuration file.

16. The method according to claim 11, further comprising:
setting a database that stores the service customization script at the SIP AS;
the step of storing service customization script comprises: storing the service customization script in the database.

17. The method according to claim 9, wherein the step of providing the service corresponding to the service customization request for the SIP client comprises:
the SIP AS providing the service script of the service corresponding to the service customization request for the SIP client, with the service customization script combined in the service script.
